(19) United States
(12) Patent Application Publication
(10) Pub. No.: US 2010/0279200 A1
(43) Pub. Date: Nov. 4, 2010

(54) Polymer electrolyte membrane and fuel cell comprising same

(75) Inventor: Ki Yun Cho, Seoul (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 11/999,371

(22) Filed: Dec. 4, 2007

(30) Foreign Application Priority Data
Aug. 24, 2007 (KR) 10-2007-0085708

(51) Int. Cl. H01M 8/10

(52) U.S. Cl. 429/492

(57) ABSTRACT

The present invention relates to an electrolyte membrane comprising an aluminum-based compound for a high-temperature fuel cell, and a polymer electrolyte membrane fuel cell comprising the electrolyte membrane. In particular, the present invention relates to an electrolyte membrane for a high-temperature fuel cell where an aluminum-based compound is added as an anionic-binding substance in the conventional electrolyte for a fuel cell, thereby improving electrochemical stability of a fuel cell and increasing cation yield of proton by preventing the elution of anions caused by water generation on electrodes, and a high-performance polymer electrolyte membrane fuel cell comprising the electrolyte membrane.

### CROSS-REFERENCE TO RELATED APPLICATION

This application claims priority to, and the benefit of, Korean Patent Application No. 10-2007-0085708, filed on Aug. 24, 2006, the entire disclosure of which is hereby incorporated by reference.

### TECHNICAL FIELD

The present invention relates to an electrolyte membrane comprising an aluminum-based compound for a high-temperature fuel cell, and a polymer electrolyte membrane fuel cell comprising the electrolyte membrane. More particularly, the present invention relates to an electrolyte membrane for a high-temperature fuel cell where an aluminum-based compound is added as an anionic-binding substance in an electrolyte for a fuel cell, thereby improving electrochemical stability of a fuel cell and increasing cation yield of proton by preventing the elution of anions caused by water generated on electrodes, and a high-performance polymer electrolyte membrane fuel cell comprising the electrolyte membrane.

### BACKGROUND ART

Recently, as the role of an alternative energy increases due to the drastic rise in oil price and more strict environmental regulations by UNFCC (the United Nations Framework Convention on Climate Change), a fuel cell has been spotlighted as the next-generation energy source. The fuel cell is a device that can convert chemical energy of a fuel to electric energy. Depending on the kind of electrolytes and the operation temperature, it may be divided into alkali fuel cell (AFC), phosphoric acid fuel cell (PAFC), molten carbonate fuel cell (MCFC), polymer electrolyte membrane fuel cell (PEMFC), solid oxide fuel cell (SOFC), etc.

In particular, polymer electrolyte membrane fuel cell (PEMFC) comprising a proton exchange membrane is considered as a clean energy source to replace fossil fuel. PEMFC shows a rapid start-up due to a low operation temperature and its easiness in manufacture using a solid electrolyte. In addition, it has superior output density and energy conversion efficiency. For these reasons, it has been intensively studied for portable, home and military uses or as an electricity source in an automobile.

As a fuel of a polymer electrolyte membrane fuel cell, hydrogen and air are considered as the most practical fuels to be supplied to a fuel electrode (cathode) and an oxidation electrode (anode), respectively. For a safety reason, hydrogen is produced by means of partial oxidation of, steam reformation and/or decomposition from fuel sources such as natural gas, gasoline, methanol instead of directly loading hydrogen. Moreover, due to its low price and convenience in transportation and storage, a direct methanol fuel cell (DMFC) has recently drawn keen attention as a portable electronic product and electricity source of an automobile. In DMFC, protons are produced by oxidation by directly supplying methanol to a fuel electrode.

The principle of electricity generation in a polymer electrolyte membrane fuel cell is illustrated in FIG. 1. Hydrogen, i.e., fuel gas, is supplied to an anode and adsorbed onto a Pt catalyst, thereby generating protons and electrons by oxidation, as shown in Scheme 1 below.

2H₂→4H⁺+4e⁻ [Scheme 1]

The generated electrons arrive at a cathode through an exterior circuit. Protons pass through a polymer electrolyte membrane and arrive at a cathode. In a cathode, as shown in Scheme 2, oxygen molecules accept electrons on a cathode and are reduced to oxygen ion. The oxygen ion reacts with a proton and generates electricity while producing water.

O₂+4e⁻→2O²⁻

2O²⁻+4H⁺→2H₂O [Scheme 2]

Polymer electrolyte membrane for a fuel cell is an electric insulator. However, during the operation of a fuel cell, this membrane serves as a medium, through which protons move from an anode to a cathode, and also separates an oxidant gas from fuel gas or liquid. Therefore, an ion exchange membrane for a fuel cell should have superior mechanical property and electrochemical stability, and also show a low ohmic loss and a superior performance in the separation of a fuel gas or a liquid at a high current density.

As described above, in a fuel cell, a cathode serves as a catalyst and promotes the oxidation-reduction reaction of fuel supplied to each electrode. Electrons and protons produced during the oxidation-reduction reaction move to a circuit and electrolyte, respectively, thereby generating electric energy. In contrast, in a secondary battery, no fuel supply is required for the reaction, and oxidation-reduction reaction proceeds by active substances contained in an anode and a cathode. For example, when lithium is discharged in a secondary battery, the reaction of an anode is that lithium is oxidized to lithium ion and is dissolved in electrolyte solution. Electrons are transferred to lithium metal in a cathode.

In conclusion, a fuel cell and a secondary battery are different with regard to reaction mechanism; water is produced as a by-product on a cathode in a fuel cell whereas electric energy is generated on a cathode in a secondary battery. The role of an electrolyte is also different; the electrolyte of a fuel cell is a medium through which proton moves while the electrolyte of a secondary battery helps lithium ions to be incorporated and separated.

An aluminum-based compound was previously used as an ingredient of an electrolyte solution in the lithium ion secondary battery field [Korean Patent No. 10-0636362]. However, the present invention, wherein an aluminum-based compound is applied to an electrolyte membrane of a fuel cell, is totally different from secondary battery in the respect of the oxidation-reduction mechanism and function of electrolyte. That is, while both the fuel cell and the secondary battery make use of oxidation and reduction reactions, they are, obviously, different from each other with regard to the mechanism of the oxidation-reduction reaction and the roles of the ingredients. Moreover, while the aforementioned patent aims only to improve the electric stability and the ion conductivity of secondary battery, the present invention aims to improve the stability by preventing the elution of acid caused by water, which is generated by the fuel supplied to fuel cell.

Although polystyrenesulfonic acid based polymer membrane was a main subject of study in the early 1960's, polymer membrane (Nafion™, Nafion) based on perfluorinated sulfonic acid was developed by E.I. Dupont de Nemours, Inc. in 1968. The superior property of this polymer membrane diverted the course of research stream to the commercial application of Nafion electrolyte membrane. The commercialized Nafion electrolyte membrane has polytetrafluoroethylene as a main body and contains sulfone functional group in side chains.

Meanwhile, various companies such as Dow Chemical in U.S. and Asahi Chemical, Asahi Glass and Tokuyama Soda in Japan disclose an ion exchange membrane based on perfluorinated sulfonic acid polymer. However, the ion exchange membrane and Nafion are too expensive (>$800/m²) to be commercialized.

Nafion electrolyte membrane is a representative ion exchange membrane prepared based on a perfluorinated sulfonic acid polymer. It has relatively high oxygen solubility, high strain point of proton in a solvated state, and superior chemical and electrochemical stabilities to a hydrocarbon-based polymer membrane due to polytetrafluoroethylene. Nafion electrolyte membrane does not show conductivity to proton until more than about 20 wt % of polymer is solvated, i.e., sulfone groups in side chain is hydrolyzed to sulfonic acid. Therefore, a reactant gas used in a polymer electrolyte membrane fuel cell is required to be saturated with water to prevent dehydration of a membrane before use.

However, the membrane becomes dry and the performance of a fuel cell drastically deteriorates at a temperature higher than 100° C. Moreover, Nafion electrolyte membrane has a thickness of about 50-175 μm considering relatively low mechanical strength. An attempt to improve mechanical property by increasing the thickness may result in decrease in the conductance of membrane. In contrast, the decrease in the membrane thickness may deteriorate the mechanical property, and may also cause a non-reacted fuel gas and liquid (methanol) to pass through a polymer membrane, thereby reducing the fuel efficiency and fuel performance due to the decrease in the number of oxygen reduction site.

To overcome the aforementioned problems, U.S. Pat. Nos. 5,547,551, 5,599,614 and 5,635,041 disclose a method to prepare a reinforced complex membrane having an improved mechanical strength by incorporating liquid-phase ion exchange polymer resin onto the conventional elongated porous polytetrafluoroethylene polymer membrane disclosed in U.S. Pat. Nos. 3,953,566 and 3,962,153. Thus prepared ion exchange polymer membrane has a lower proton conductivity (Ω⁻¹cm⁻¹) and an improved mechanical property as compared to those of Nafion membrane, thus enabling the manufacture of a polymer thin membrane having a thickness of about 25 μm.

Besides, U.S. Pat. No. 6,130,175 discloses a method of improving ion conductivity and mechanical property by incorporating ion exchange resin having perfluorinated carboxylic functionality such as methyl ester precursor as a first ion exchange substance onto a side of porous polytetrafluoroethylene film and also incorporating ion exchange resin having perfluorinated sulfonic functionality as a second ion exchange onto another side, thereby filling pores near the surface. Moreover, U.S. Pat. No. 6,042,958 discloses a method of attaching non-woven glass fiber substrate and incorporating perfluorinated sulfone-based polymer on both sides of porous polytetrafluoroethylene film.

However, the conventional complex polymer electrolyte membrane, which is prepared by using porous polytetrafluoroethylene membrane, has serious problems as follows. As the thickness of membrane is decreased to about 25 μm to increase the conductance, the mechanical strength such as tear strength is deteriorated. Further, the use of high-priced porous polytetrafluoroethylene support having a porosity of 80% decreases the price competitiveness as compared to the conventional Nafion resin. Moreover, the manufacture process takes a relatively long time and should be conducted discontinuously because ion exchange resin should be incorporated onto polytetrafluoroethylene film having a very low wettability. In particular, the polytetrafluoroethylene film shows very low adhesive property due to a relatively high hydrophobicity. Therefore, depending on the conditions of a fuel cell operation such as temperature or humidity, adhesive property between Nafion and polytetrafluoroethylene support may be drastically lowered, thus decreasing the performance of separating fuel and oxdant gas.

Meanwhile, hydrogen manufactured from natural gas, gasoline and methanol contains a trace of carbon monoxide (CO). Even several ppm of carbon monoxide adsorbed on Pt catalyst can inhibit the oxidation of fuel, thus drastically deteriorating the catalyst performance. Therefore, there have been attempts made to decrease the content of carbon monoxide in a fuel gas such as using various alloy catalysts resistant to carbon monoxide, and also a method of inhibiting the exothermal adsorption of carbon monoxide by increasing the operation temperature of a fuel cell to one higher than 120° C. When a polymer electrolyte membrane fuel cell is operated at a high temperature, oxidation-reduction rate and battery efficiency may be improved. For this reason, the attention has been increasing about a proton exchange membrane that has superior proton conductivity even at high temperature.

U.S. Pat. No. 5,525,436 discloses an electrolyte membrane prepared by removing solvent from polybenzimidazole solution, followed by doping with strong acid such as sulfuric acid and drying. Moreover, U.S. Pat. Nos. 5,091,087, 5,599,639 and 6,187,231 disclose a process of preparing an electrolyte membrane comprising the steps of (i) preparing a complex film by coating polyimide on polybenzimidazole and compression molding, (ii) preparing a porous polybenzimidazole film by extracting polyimide with a solvent such as dichloromethane, and (c) preparing an electrolyte membrane by doping the film with a strong acid or by alkylsulfonating polybenzimidazole treated with alkali hydride, followed by solidification of polybenzimidazole solution doped with a strong acid in a bath of a non-solvent or a non-solvent and a solvent mixture. With regard to a sulfonated polymer used in electrolyte membranes, WO 00/77874 discloses a polyphosphogen, and Japanese Patent Nos. 11116679 and 11067224 disclose polyether sulfone. Poly(ether-ester ketone) and poly(4-phenoxybenzoyl-1,4-phenylene) are also reported.

However, non-florine-based polymer such as polybenzimidazole may decrease proton conductivity due to a relatively low hydrophilicity despite the increase in methanol separation property.

Thus, there have been attempts made to use substances that are superior in proton conductivity, electrochemical stability and thermal stability even under a high-temperature and non-aqueous condition as a polymer electrolyte membrane. Japanese Patent No. 2000-195528 discloses a polymer electrolyte membrane prepared by doping phosphoric acid in polybenzimidazole-based polymer. However, this polymer electrolyte membrane has a problem in that the phosphoric acid is eluted by water generated on both electrodes, which results in decrease in proton conductivity of electrolyte membrane. Moreover, when the doping amount of an acid is increased to maintain the proton conductivity of a polymer electrolyte membrane, the mechanical property of membrane becomes seriously deteriorated.

### SUMMARY

The present invention has been completed by finding that the addition of aluminum-based compound of Formula 1 below to a conventional electrolyte membrane comprising a polymer matrix and an acid may maintain the mechanical strength of polymer electrolyte membrane even at a relatively high acid doping amount, and may also inhibit the elution of anions caused by dissociation of acid and the proton conductivity of polymer electrolyte membrane especially at a relatively high temperature.

Therefore, the present invention aims to provide an electrolyte membrane for a high-temperature fuel cell, which maintains superior electrochemical stability, cation yield and mechanical strength even at a relatively high temperature and even in a comparatively lower thickness, thereby enabling to reduce the manufacture cost.

Further, the present invention also aims to provide a polymer electrolyte membrane fuel cell comprising an electrolyte membrane for a high-temperature fuel cell herein.

One aspect of the present invention provides polymer electrolyte membranes for high-temperature fuel cell comprising 4-95 wt % of a polymer matrix, 4-95 wt % of an acid and 1-40 wt % of an aluminum-based compound of Formula 1:

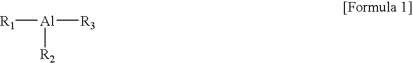

wherein R₁, R₂ and R₃ are the same or different, and each is selected from the group consisting of

CH₃O, CF₃CH₂O, C₃F₇CH₂O, (CF₃)₂CHO, (CF₃)₂C(C₆H₅)O, (CF₃)₃CO, C₆H₅O, FC₆H₄O, F₂C₆H₃O, F₄C₆HO, C₆F₅O, CF₃C₆H₄O, (CF₃)₂C₆H₃O and C₆F₅.

Another aspect of the present invention provides polymer electrolyte membrane fuel cells comprising the polymer electrolyte membranes.

Other aspects of the invention are discussed infra.

### BRIEF DESCRIPTION OF DRAWINGS

FIG. 1 schematically illustrates the general structure and operation principle of the polymer electrolyte membrane fuel cell (PEMFC).

FIG. 2 shows the function of anionic-binding substance used in the present invention.

### DETAILED DESCRIPTION

Reference will now be made in detail to the preferred embodiment of the present invention, examples of which are illustrated in the drawings attached hereinafter. The embodiments are described below so as to explain the present invention by referring to the figures.

The aluminum-based compound of Formula 1 was reported as an ingredient in lithium ion secondary battery [Korean Patent No. 10-0636362]. The present invention discloses the application of an aluminum-based compound to the electrolyte membrane of a fuel cell which is completely different from a secondary battery in terms of the purpose and the role of the electrolyte membrane.

More specifically, unlike a secondary battery, a fuel cell has a problem that water generated on electrodes can cause the elution of acid doped on a polymer electrolyte membrane. Thus, the electrolyte membrane is used for a different purpose, i.e., for the inhibition of the elution in the present invention.

Furthermore, in an electrolyte membrane of a fuel cell, reactants are introduced from the outside and products produced therein are discharged to the outside, and the water produced thereof causes the doped acid to be eluted, thereby decreasing the stability of non-aqueous polymer electrolyte membrane. In contrast, in a secondary battery, charge-discharge is repeated without the change in electrolyte solution. Thus, there is no acid elution in a secondary battery.

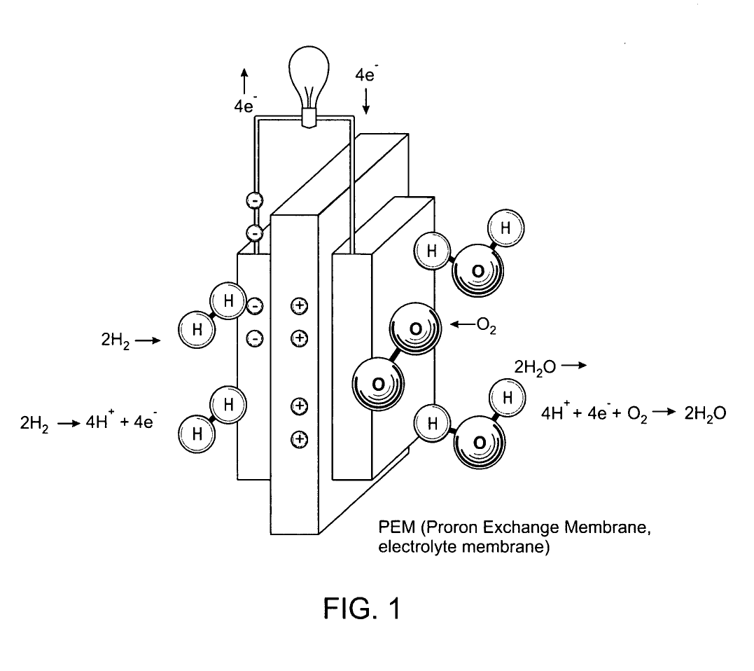

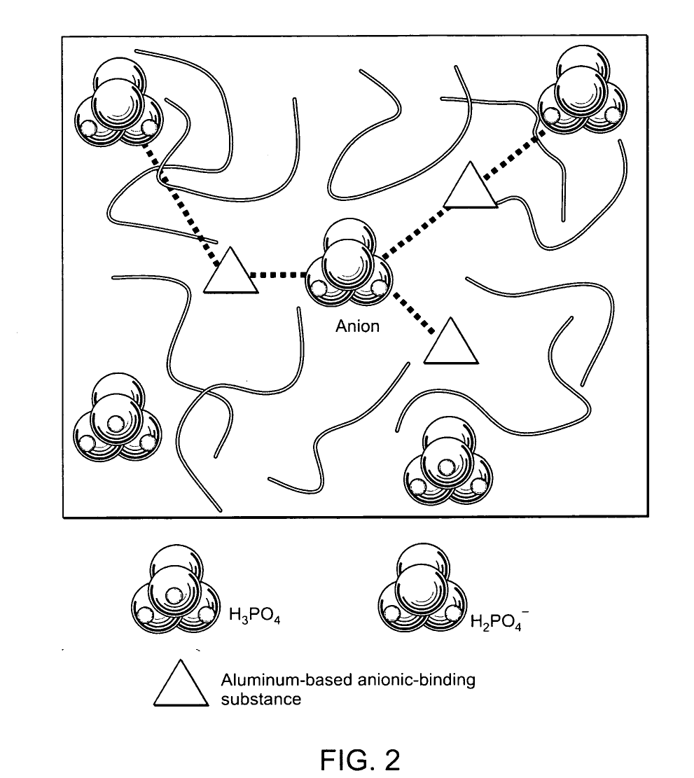

The aluminum-based compound of Formula 1, and an essential ingredient in the present invention, is used as an anionic-binding substance in an electrolyte membrane for a high-temperature fuel cell. FIG. 1 schematically illustrates the general structure and operation principle of the polymer electrolyte membrane fuel cell (PEMFC), where protons generated on an anode move to a cathode through an electrolyte membrane. FIG. 2 shows the function of an anionic-binding substance used in the present invention. An ionized aluminum-based compound binds anions of an acid by an ion-dipole bond, thus preventing the elution of anionic acid. Due to this bond, the mobility of protons increases and the electrochemical stability and cation yield of high-temperature polymer electrolyte membrane fuel cell may be improved. Further, the aluminum compound may serve as a mechanical crosslinker and improve the mechanical property.

An aluminum compound of Formula 1 herein may be prepared by a conventional process [e.g., Synthesis of polybutadiene-polylactide diblock copolymer using aluminum alkoxide macro initiators kinetics and mechanism, Macromolecules 33(20), 2000, 7395-7403 p; Synthesis of amine-terminated aliphatic polycarbonates via Al(Et)₂(OR)-initiated polymerization, Macromolecules 30(20), 1997, 6074-6076 p].

For example, aluminum compound of Formula 1, which may be added in a high-temperature fuel cell polymer electrolyte membrane herein, may be prepared as described below. Reaction is conducted by adding an aluminum solution dropwisely at a rate of 0.35±0.5 g/min in R—OH compound containing monohydroxyl group (—OH), where R is CH₃O, CF₃CH₂O, C₃F₇CH₂O, (CF₃)₂CHO, (CF₃)₂C(C₆H₅)O, (CF₃)₃CO, C₆H₅O, FC₆H₄O, F₂C₆H₃O, F₄C₆HO, C₆F₅O, CF₃C₆H₄O, (CF₃)₂C₆H₃O or C₆F₅. Trimethyl aluminum or triethyl aluminum solution may be used as the aluminum solution. The R—OH compound is used in the amount of three equivalents, thus removing non-reacted trimethyl aluminum or triethyl aluminum. Further, due to a relatively high reactivity of aluminum solution to moisture and oxygen, the reaction of aluminum compound is conducted with trimethyl aluminum or triethyl aluminum in a glove box at room temperature for 24-48 hours. After the reaction is completed, the product is purified by filtration and vacuum-dried at about 80±5° C. for 12-48 hours, thereby generating powders. The structure of the powders is ascertained by a spectroscopy.

When the amount of the aluminum-based compound of Formula 1 is too low, the aluminum-based compound may not serve as an anionic-binding substance sufficiently, thus generating the elution of anions. As a result, the performance of a fuel cell may not be sufficiently improved because it is difficult to improve electrochemical stability and to increase the dissociation of cations. By contrast, when the amount is higher than 40 wt %, the aluminum-based compound may serve as impurity and decrease the proton conductivity, thereby deteriorating the performance of a fuel cell. Further, mechanical stability cannot be secured when the amount is greater than 40 wt %.

The polymer matrix used in a polymer electrolyte herein serves as a binding substance of polymer electrolyte membrane and as a proton conductor and also dissociates the acid. Thus, the polymer matrix is also added in an electrolyte for high-temperature fuel cell. Examples of the polymer matrix include without limitation polybenzimidazoles such as poly[2,2′-(m-phenylene)-5,5′-bibenzimidazole] (‘PBI’) and poly(2,5-benzimidazole) (‘ABPBI’), polybenzothiazoles, polybenzoxazoles, polyimides, polycarbonates, a copolymer or blend thereof. Further, at least one porous matrix selected among polytetrafluoroethylene, polyvinylidene fluoride, polyethylene, polypropylene, polyimide, polybenzoxazole, polybenzimidazole and a copolymer thereof may also added to improve mechanical property. When the amount of the polymer matrix is too little, the mechanical strength may not be sufficient for forming a membrane. When the amount is excessive, on the contrary, the conductivity of proton may not be sufficient and increase the resistance. A preferable amount is 4-95 wt %.

Moreover, examples of an acid used in a polymer electrolyte herein include without limitation phosphoric acid, acetic acid, nitric acid, sulfuric acid, formic acid, a derivative thereof and a mixture thereof. Particularly, considering the remarkably low temperature dependency of conductivity, it is preferred to use phosphoric acid or its derivative with thermal stability. This acid is preferably used in the amount of 4-95 wt %. When the amount is too low, the proton conductivity may not be sufficient. In contrast, when the amount is excessive, the mechanical stability of the polymer electrolyte membrane may not be sufficient.

In a polymer electrolyte membrane herein, the aluminum-based compound binds anions generated when acid is dissociated and improves the mobility of protons. This compound also prevents the acid elution, which is caused by water generated on electrodes, thereby maintaining the electrochemical stability on the surface of a unit cell and improving the ion conductivity and long-term stability even at a high-temperature non-aqueous condition of 30-200° C. Moreover, one of the features of the present invention lies in the use of polymer matrix having a sufficient mechanical property, thereby maintaining superior mechanical strength even in a relatively low thickness.

A polymer electrolyte membrane herein may be prepared by a conventional process. For example, an aluminum-based compound and polymer monomer added in 3-neck or 4-neck round flask reactor containing an acid as a solvent, and the reaction is conducted at 120-200° C. for 24 hours under a nitrogen or helium circumstance. The product is cast on a glass plate at room temperature by using Doctor Blade or slot die, and placed at room temperature for 24-80 hours. Moisture in the air hydrolyzes polyphosphoric acid added as a polymerizing solvent, thus forming phosphoric acid and polymer electrolyte membrane.

As described above, a polymer electrolyte membrane disclosed in the present invention is suitable for a proton exchange membrane fuel cell such as alkali fuel cell (AFC), phosphoric acid fuel cell (PAFC), molten carbonate fuel cell (MCFC) and solid oxide fuel cell (SOFC) as well as for a polymer electrolyte membrane fuel cell (PEMFC).

### EXAMPLES

The present invention is described more specifically by the following Examples. Examples herein are meant only to illustrate the present invention, but they should not be construed as limiting the scope of the claimed invention.

### Example 1

A 3-neck reactor was placed under nitrogen atmosphere, and 3,4-diaminobenzoic acid monomer was added in the amount of 4.95 wt % relative to a solvent (polyphosphoric acid), followed by the addition of aluminum-based compound (trishexafluoroisopropyl aluminate) in the amount of 3 wt % relative to the solvent. Polymerization is conducted at 200° C.

The polymer was cast on a glass by using a doctor blade, and stored in air for more than 36 hours. Polyphosphoric acid was hydrolyzed with moisture and converted to phosphoric acid.

Thus prepared polymer electrolyte was stacked between Teflon electrodes to combine a cell. Electrolyte resistance was measured by an AC impedance method, and proton conductivity was calculated based on the resistance. Proton conductivity (proton mobility) and mechanical strength are presented in Table 3.

### Examples 2-4

A polymer electrolyte membrane was prepared same as in Example 1 except the kind and the content of ingredients are changed as shown in Table 1.

TABLE 1

| | aluminum | | Polymer | | | |
|---|---|---|---|---|---|---|
| | compound | | matrix | | Acid | |
| Exam- | | Content | | Content | | Content |
| ples | Type | (wt %) | Kind | (wt %) | Kind | (wt %) |
| Ex. 1 | THFIPA¹⁾ | 15 | ABPBI | 40 | Phosphoric | 45 |
| Ex. 2 | | 25 | | 20 | acid | 55 |
| Ex. 3 | TPFPA²⁾ | 25 | | 40 | | 35 |
| Ex. 4 | TPFPA | 20 | | 30 | | 50 |
| Comp. | — | 0 | | 47 | | 53 |
| Ex. 1 | | | | | | |
| Comp. | — | 0 | | 27 | | 73 |
| Ex. 2 | | | | | | |
| Comp. | — | 0 | | 53 | | 47 |
| Ex. 3 | | | | | | |
| Comp. | — | 0 | | 38 | | 62 |
| Ex. 4 | | | | | | |
| Comp. | THFIPA | 60 | | 15 | | 25 |
| Ex. 5 | | | | | | |

¹⁾THFIPA: trishexafluoroisopropyl aluminate
²⁾TPFPA: trispentafluorophenyl aluminate
3) ABPBI: aminobenzoic polybenzimidazole

### Comparative Examples 1-5

Polymer electrolyte was prepared in Comparative Examples 1-4 same as in Examples 1-4 except that anionic-binding substance, i.e., an aluminum compound, was not incorporated. In Comparative Example 5, a polymer electrolyte was prepared by using 60 wt % of an aluminum compound, 15 wt % of a polymer matrix and 25 wt % of phosphoric acid 25. Proton conductivity and mechanical strength were measured, and the results are presented in Table 2.

### Test Example 1

Accelerated elution test of an acid was conducted to observe the anion binding property of polymer electrolyte prepared in Examples 1-4 and Comparative Examples 1-4. The polymer electrolyte was immersed 80 mL of water at room temperature for 30 minutes, and the degree of acid elution was measured by means of titration. The results are presented in Table 2. The degree of acid elution refers to the amount of acid that is dissolved in water after eluting from the polymer electrolyte membrane immersed in water.

### Test Example 2

The anion binding property of polymer electrolyte prepared in Examples 1-4 and Comparative Examples 1-4 was observed by measuring mechanical strength. Mechanical strength was measured with UTM (universal test machine) by extending both ends of a membrane.

TABLE 2

| | | Acid | | Mechanical |
|---|---|---|---|---|
| | Proton conductivity | elution | Thickness | strength |
| | (S/cm, at 150° C.) | (%) | (μm) | (MPa) |
| Ex. 1 | 3.0 × 10⁻² | 80 | 115 | 25 |
| Ex. 2 | 4.5 × 10⁻¹ | 54 | 120 | 5 |
| Ex. 3 | 2.0 × 10⁻¹ | 49 | 132 | 17 |
| Ex. 4 | 5 × 10⁻¹ | 72 | 122 | 10 |
| Comp. Ex. 1 | 2.8 × 10⁻² | 96 | 150 | 24 |
| Comp. Ex. 2 | 3.1 × 10⁻¹ | 99 | 127 | 2 |
| Comp. Ex. 3 | 8.9 × 10⁻² | 98 | 132 | 16 |
| Comp. Ex. 4 | 7.8 × 10⁻² | 98 | 127 | 8.8 |

| | |
|---|---|
| Comp. Ex. 5 | Membrane not formed |

As shown in Table 2, acid elution decreases as the binding force between the acid and the polymer electrolyte membrane increases. In Comparative Examples 1-4, about 96-99% of an acid in the polymer electrolyte membrane eluted into water. However, the acid elution was suppressed up to 49% according to the present invention. The suppression of acid elution is expected to increase the long-term stability of the polymer electrolyte membrane. Membrane was not formed in Comparative Example 5 due to insufficient mechanical strength caused by an excessive amount of an aluminum-based compound.

An electrolyte for a high-temperature fuel cell prepared by incorporating anion binding agent according to the present invention and a polymer electrolyte membrane fuel cell comprising the electrolyte is superior in mechanical strength as compared to the conventional electrolyte for a fuel cell and the conventional polymer electrolyte membrane fuel cell.

Due to the incorporation of aluminum-based compound, an electrolyte for high-temperature fuel cell according to the present invention and a polymer electrolyte membrane fuel cell for the electrolyte herein maintain a relatively high electrochemical stability and cation yield and mechanical strength even at a relatively high temperature and even when the thickness is lower than that of the conventional electrolyte for a fuel cell and the polymer electrolyte membrane fuel cell. As a result, the present invention has an advantage of reduction in the manufacture cost.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A polymer electrolyte membrane for high-temperature fuel cell comprising 4-95 wt % of a polymer matrix, 4-95 wt % of an acid and 1-40 wt % of an aluminum-based compound of Formula 1: 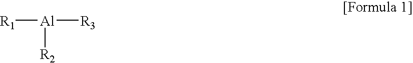
wherein R₁, R₂ and R₃ are the same or different, and each is selected from the group consisting of CH₃O, CF₃CH₂O, C₃F₇CH₂O, (CF₃)₂CHO, (CF₃)₂C(C₆H₅)O, (CF₃)₃CO, C₆H₅O, FC₆H₄O, F₂C₆H₃O, F₄C₆HO, C₆F₅O, CF₃C₆H₄O, (CF₃)₂C₆H₃O and C₆F₅.

2. The polymer electrolyte membrane of claim 1, wherein the polymer matrix is selected from the group consisting of polybenzimidazoles, polybenzothiazoles, polybenzoxazoles, polyimides, polycarbonates, a mixture thereof and a copolymer thereof.

3. The polymer electrolyte membrane of claim 1, wherein the acid is selected from the group consisting of a phosphoric acid, an acetic acid, a nitric acid, a sulfuric acid, a formic acid and a mixture thereof.

4. A high-temperature fuel cell comprising the polymer electrolyte membrane according to claim 1.

5. The high-temperature fuel cell of claim 4, wherein the reaction in a fuel cell is conducted at 80-200° C.
